(19) United States
(12) Patent Application Publication
(10) Pub. No.: US 2022/0013124 A1
(43) Pub. Date: Jan. 13, 2022

(54) METHOD AND APPARATUS FOR GENERATING PERSONALIZED LIP READING MODEL

(71) Applicant: Samsung Electronics Co., Ltd., Suwon-si (KR)

(72) Inventors: Sangki KANG, Suwon-si (KR); Sungwoon JANG, Suwon-si (KR)

(21) Appl. No.: 17/294,382

(22) PCT Filed: Sep. 30, 2019
(86) PCT No.: PCT/KR2019/012775

§ 371 Date: May 14, 2021

(30) Foreign Application Priority Data
Nov. 15, 2018 (KR) 10-2018-0140812

(51) Int. Cl. G10L 15/25; G06K 9/00; G10L 15/26

(52) U.S. Cl. CPC G10L 15/25; G10L 15/26; G06K 9/00302

(57) ABSTRACT

Disclosed in various embodiments of the present invention are a method and an apparatus, the apparatus comprising: a memory; a display; a camera; and a processor, wherein the processor is configured to display a user interface including at least one phrase on the display, obtain a user video associated with the phrase from the camera, verify the user video depending on whether voice is included in the user video, store the user video in the memory as a video for utilization as a personalized lip reading model on the basis of the verification result. Various embodiments are possible.

### CROSS-REFERENCE TO RELATED APPLICATIONS

This application is a 371 of International Application No. PCT/KR2019/012775 filed on Sep. 30, 2019, which claims priority to Korean Patent Application No. 10-2018-0140812 filed on Nov. 15, 2018, the disclosures of which are herein incorporated by reference in their entirety.

### BACKGROUND

### 1. Field

Various embodiments of the disclosure provide a method and a device for generating a personalized lip reading model.

### 2. Description of Related Art

Development of digital technologies has been followed by widespread use of various types of electronic devices, such as a personal digital assistant (PDA), an electronic wallet, a smartphone, a tablet personal computer, and a wearable device. In order to support and enhance functions of such electronic devices, the hardware part and/or software part of electronic devices are continuously improved. For example, an electronic device may provide an intelligence agent service such that the same performs various functions in response to a user speech input.

The intelligence agent service may recognize a speech, analyze (or understand) the recognized speech, and provide a service desired by the user. For example, if the user speaks “Text Jack to let him know that I will be late a little”, the electronic device may execute a message application and enter a message composition field. The electronic device may then designate, as the message recipient, the telephone number of a person registered as “Jack” in the telephone directory, may compose a message “I will be late a little”, and may transmit the message. Since the intelligence agent service operates based on a user speech, the speech recognition performance can be improved only if there is little noise (for example, peripheral noise) other than the user's speech. For example, there may be a difference in performance between when a user speech is recognized in a quiet state (for example, a low level of noise) and when a user speech is recognized with peripheral noise (for example, a high level of peripheral noise).

The higher the speech recognition performance of an electronic device, the higher accuracy the intelligence agent service may have. In order to improve the speech recognition performance, the electronic device may use a lip reading technology such that the shape of the user's mouth, together with a user speech, may be used to provide the intelligence agent service. The electronic device may detect the timepoint at which a user utterance starts and the timepoint at which the user utterance ends, based on the shape of the user's mouth, or may correct an inaccurate pronunciation with reference to the mouth shape, thereby recognizing the speech more accurately.

According to the conventional lip reading technology, images including lip movements during multiple unspecific utterances are used for learning, in order to recognize mouth shapes. If multiple unspecific utterances are learnt, various errors may because respective users have different mouth shapes, different skin colors around mouths, different utterance rates, and different personal accents. The more utterance images are learnt, the better the mouth shape recognition performance may be. However, there may be a limit to developing the lip reading technology according to linguistic characteristics (for example, personal utterance habits and dialects).

Various embodiments may disclose a method and a device wherein the validity of an image is determined based on a distinction between an image including a speech and an image including no speech, and the image is useable as a personalized lip reading model according to the result of determination.

### SUMMARY

An electronic device according to various embodiments of the disclosure may include: a memory; a display; a camera; and a processor. The processor may be configured to: display a user interface, including at least one expression, on the display; acquire a user image associated with the expression from the camera; verify the user image, based on whether speech is included in the user image; and store the user image in the memory as an image which is to be used as a personalized lip reading model, based on a result of the verification.

An electronic device according to various embodiments of the disclosure may include: a memory; a display; and a processor. The processor may be configured to: provide an image list including at least one image, based on a request to use the image as a personalized lip reading model; select at least one image from the image list; and verify the selected image and store the selected image in the memory as an image which is to be used as the personalized lip reading model.

An operation method of an electronic device according to various embodiments of the disclosure may include: driving a camera of the electronic device in response to a speech call; determining whether movement of a mouth is detected in a user image received from the driven camera; recording the user image when movement of the mouth is detected in the user image; providing a service corresponding to speech received during the speech call; and using the recorded user image as a personalized lip reading model.

According to various embodiments, the validity of an image is determined based on a distinction between an image including a speech and an image including no speech, and the image is useable as a personalized lip reading model according to the result of determination.

According to various embodiments, a personalized lip reading model is learnt by using images of a user who has uttered expressions provided on a user interface, thereby generating a personalized lip reading model that reflects personal utterance characteristics.

According to various embodiments, a personalized lip reading model is used to correct inaccurate pronunciations with reference to mouth shapes, thereby improving the speech recognition accuracy.

According to various embodiments, a user interface including expressions is provided, images of the user who has uttered the provided expressions are acquired, and the acquired images are useable as a personalized lip reading model or a normal lip reading model.

### BRIEF DESCRIPTION OF THE DRAWINGS

FIG. 1 is a block diagram of an electronic device 101 in a network environment 100 according to various embodiments;

FIG. 2 is a flowchart 200 illustrating a method for generating a personalized lip reading model in an electronic device according to various embodiments;

FIGS. 3A and 3B illustrate an example of providing a user interface for acquiring a user image in an electronic device according to various embodiments;

FIG. 4 is a flowchart 400 illustrating a method for verifying a user image, which does not include speech, in an electronic device according to various embodiments;

FIG. 5 is a flowchart 500 illustrating a method for verifying a user image, which includes speech, in an electronic device according to various embodiments;

FIG. 6 is a flowchart 600 illustrating a method for using a pre-stored image as a personalized lip reading model in an electronic device according to various embodiments;

FIG. 7 illustrates an example of providing a user interface for selecting a pre-stored image in an electronic device according to various embodiments;

FIG. 8 is a flowchart 800 illustrating a method for using a pre-stored image as a personalized lip reading model in an electronic device according to various embodiments;

FIG. 9 is a flowchart 900 illustrating a method for using a pre-stored image, which includes two or more users, as a personalized lip reading model in an electronic device according to various embodiments;

FIG. 10 is a flowchart 1000 illustrating a method for acquiring a user image during a video call and using the user image as a personalized lip reading model in an electronic device according to various embodiments;

FIG. 11 illustrates an example of providing a user interface including a video call in an electronic device according to various embodiments;

FIG. 12 is a flowchart 1200 illustrating a method for acquiring a user image during an integrated intelligence (AI) system call and using the user image as a personalized lip reading model in an electronic device according to various embodiments; and

FIG. 13 illustrates an example of providing a user interface associated with a speech call in an electronic device according to various embodiments.

### DETAILED DESCRIPTION

The electronic device according to various embodiments may be one of various types of electronic devices. The electronic devices may include, for example, a portable communication device (e.g., a smart phone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

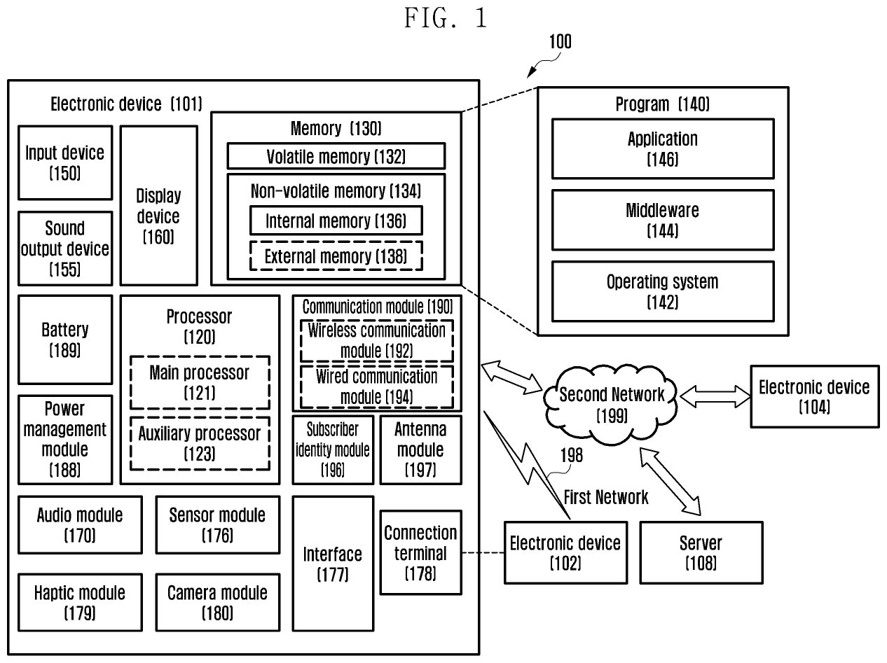

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an example embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An electronic device (e.g., the electronic device 101 in FIG. 1) according to various embodiments of the disclosure may include: a memory (e.g., the memory 130 in FIG. 1); a display (e.g., the display device 160 in FIG. 1); a camera (e.g., the camera module 180 in FIG. 1); and a processor (e.g., the processor 120 in FIG. 1), wherein the processor is configured to: display a user interface, including at least one expression, on the display; acquire a user image associated with the expression from the camera; verify the user image, based on whether speech is included in the user image; and store the user image in memory as an image which is to be used as a personalized lip reading model, based on the result of the verification.

The processor may be configured to: when speech is included in the user image, extract the speech included in the user image; convert the extracted speech into text; and verify the user image, based on whether the converted text matches the expression.

The processor may be configured to: detect the movement of a mouth included in the user image when speech is not included in the user image; recognize a word or a sentence corresponding to the detected movement of the mouth; and verify the user image, based on whether the recognized word or sentence matches the expression.

The processor may be configured to use the user image as a personalized lip reading model corresponding to the expression when a word or sentence recognized from the user image is identical to the expression.

The processor may be configured to: when a word or sentence recognized from the user image is not identical to the expression, provide a user interface including the recognized word or sentence; and store the user image in the memory as an image which is to be used, based on a user's selection, as a personalized lip reading model corresponding to the recognized word or sentence.

The processor may be configured to: receive, from the user, a request to correct the recognized word or sentence; and store the user image in the memory as an image which is to be used as a personalized lip reading model corresponding to the word or sentence corrected by the correction request.

The processor may be configured to provide a user interface including an expression different from the expression when a word or sentence recognized from the user image is not identical to the expression.

An electronic device (e.g., the electronic device 101 in FIG. 1) according to various embodiments of the disclosure may include a memory (e.g., the memory 130 in FIG. 1), a display (e.g., the display device 160 in FIG. 1), and a processor (e.g., the processor 120 in FIG. 1), wherein the processor is configured to: provide an image list including at least one image, based on a request to use the image as a personalized lip reading model; select at least one image from the image list; and verify the selected image and store the selected image in the memory as an image which is to be used as the personalized lip reading model.

The processor may be configured to provide the image list, based on a file extension or a reproduction time of each of images stored in the memory.

The processor may be configured to: determine whether the selected image is usable as the personalized lip reading model; and request image reselection when it is determined that the selected image is not usable as the personalized lip reading model.

The processor may be configured to: recognize a face from the selected image; determine whether the recognized face corresponds to a user registered in the electronic device; and output an error message when it is determined that the recognized face does not correspond to the user registered in the electronic device.

The processor may be configured to: recognize faces from the selected image; and output an error message when the number of recognized faces is equal to or greater than two.

The processor may be configured to: recognize faces from the selected image; and, when the number of recognized faces is equal to or greater than two, recognize a user registered in the electronic device from among the two or more faces; recognize a word or a sentence, based on the shape of the mouth of the recognized user; and perform a lip reading model usage process for the recognized word or sentence.

The processor may be configured to: detect a lip reading usage section from the selected image; convert speech extracted from the detected lip reading usage section into text; provide a user interface including the converted text; and store the selected image in the memory as an image which is to be used as the personalized lip reading model, based on a user's selection.

The processor may be configured to: receive a registration request from the user when the converted text corresponds to an expression intended by the user; and use, based on the registration request, the selected image as a personalized lip reading model corresponding to the converted text.

The processor may be configured to include an image related to a video call in the image list, based on the configuration of the electronic device or a user's selection.

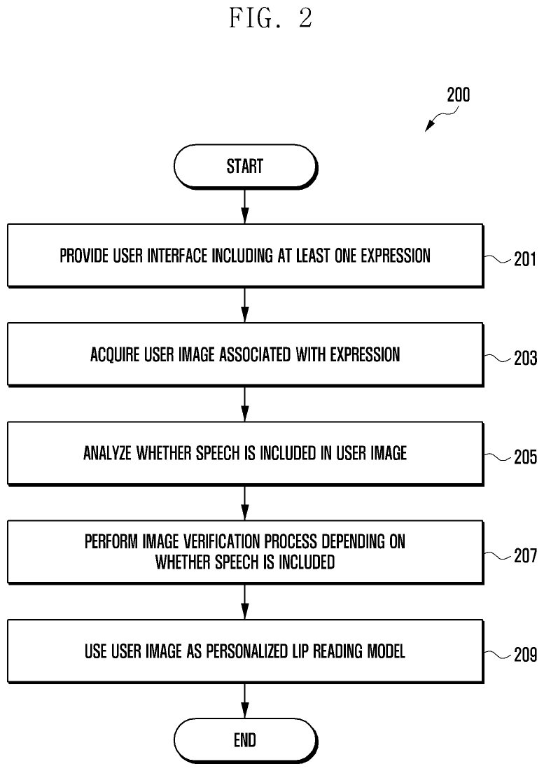

FIG. 2 is a flowchart 200 illustrating a method for generating a personalized lip reading model in an electronic device according to various embodiments.

Referring to FIG. 2, in operation 201, a processor (e.g., the processor 120 in FIG. 1) of an electronic device (e.g., the electronic device 101 in FIG. 1) according to various embodiments may provide a user image including at least one expression. The expression may include words having the minimum meaning usable to learn a lip reading model. For example, the expression may include a word (or a keyword) consisting of at least three syllables. The expression may be expressed by a single word such as “elephant”, a combination of two words such as “Good morning”, a phrase such as “Hi, Hello!”, or a sentence such as “I am a woman”. The processor 120 may display a user interface including at least one expression on a display (e.g., the display device 160 in FIG. 1). Alternatively, the processor 120 may output speech corresponding to the expression through a speaker (e.g., the sound output device 155 in FIG. 1).

According to various embodiments, the processor 120 may provide a user interface for generating a personalized lip reading model. A method for generating a personalized lip reading model may use an image pre-stored in the electronic device 101, or may use an image newly acquired from a user. In FIG. 2, a description will be made of a method for generating a personalized lip reading model by using an image newly acquired from a user. The processor 120 may provide a user interface for generating a personalized lip reading model, and may provide, when “directly learn” is selected by a user in the provided interface, a user interface including the at least one expression.

In operation 203, the processor 120 may acquire a user image associated with the expression. The processor 120 may drive (or activate) a camera (e.g., the camera module 180 in FIG. 1) while or after providing the user interface. Herein, the driven camera module 180 may be a front camera capable of capturing an image of a user's face. The processor 120 may capture an image of the face of a user uttering the expression from the camera module 180. Further, the processor 120 may activate a microphone (e.g., the input device 150 in FIG. 1) while driving the camera module 180, so as to acquire the speech of the user that utters the expression. The user image may include an audio signal (e.g., user speech) or a video signal (e.g., the user's face).

According to various embodiments, the processor 120 may adjust the image-capturing mode of the camera module 180 in order to use a user image acquired from the camera module 180 as a personalized lip reading model. For example, when the user image is very dark or bright due to the influence of ambient brightness, it is difficult to use the user image as a personalized lip reading model, and thus the processor 120 may adjust the image-capturing mode of the camera module 180. The processor 120 may detect the brightness of a user image, may determine whether the detected brightness corresponds to a preset image-capturing state, and, when the detected brightness does not correspond to the preset image-capturing state, may adjust the image-capturing mode of the camera module 180. Alternatively, the processor 120 may adjust the magnitude of an audio signal acquired from the input device 150. For example, when the magnitude of an audio signal is large and thus an echo occurs, speech recognition is difficult, and thus the processor 120 may adjust the magnitude of the signal received from the input device 150. Alternatively, when noise (e.g., ambient noise) that has a value equal to or greater than a reference value is detected in the audio signal acquired from the input device 150, speech recognition is difficult, and thus the processor 120 may request a user to capture an image in a quiet place.

According to various embodiments, the processor 120 may analyze the audio signal or the video signal to determine whether the user ends utterance. The processor 120 may determine whether utterance is ended, by determining whether an audio signal is detected from the input device 150 after an expression utterance time (e.g., 3 seconds, 5 seconds, or 10 seconds) passes. The expression utterance time may vary depending on the expression provided in the user interface. For example, the processor 120 may adjust the expression utterance time according to the number of syllables. The processor 120 may determine whether utterance is ended, by determining whether movement is detected in a video signal received from the camera module 180 after the expression utterance time passes. The movement of the video signal may refer to a change in the shape of a user's face, lips or mouth. When it is determined that the user has ended utterance, the processor 120 may stop driving the camera module 180 and the input device 150 and acquire a user image. According to various embodiments, the processor 120 may determine whether the user's face included in the video signal corresponds to a user registered in the electronic device 101. The processor 120 may perform operation 205 when the user's face included in the video signal corresponds to a user registered in the electronic device 101.

In operation 205, the processor 120 may analyze whether speech is included in a user image. The processor 120 may remove noise (e.g., ambient noise) from the user image, and may determine whether speech of a user that utters the expression is included in the user image from which the noise is removed. The user may read the expression provided in operation 201 out loud or silently. Alternatively, the user may read the expression in a quiet voice. If the user reads in a quiet voice, the user's speech may be removed when removing the noise. Alternatively, when the user reads in a quiet voice, the sound may not be loud enough to recognize the speech (e.g., having a value equal to or greater than a reference value). The processor 120 may determine whether user speech having a value equal to or greater than a reference value is detected from the user image, and when user speech having a value equal to or greater than the reference value is detected, may determine that speech is included in the user image. The processor 120 may determine that speech is not included in the user image when user speech that has a value equal to or smaller than the reference value is detected from the user image. The technology for determining whether user speech is included in an image corresponds to the prior art, and thus a detailed description thereof may be omitted.

According to various embodiments, the processor 120 may determine whether an audio signal (e.g., user speech acquired from a microphone) is detected in the user image. According to various embodiments, when user speech is included in the audio signal, the processor 120 may determine whether the user speech corresponds to a user registered in the electronic device 101. The processor 120 may perform operation 207 when the user speech included in the audio signal corresponds to a user registered in the electronic device 101.

In operation 207, the processor 120 may perform an image verification process according to whether speech is included. For example, when speech is included in the user image, the processor 120 may perform a verification process (e.g., a speech verification process) on the image including the speech. The speech verification process may be a process of extracting the speech included in the user image, converting the extracted speech into text by using automatic speech recognition (ASR) technology, and determining whether the converted text matches the expression. According to various embodiments, the processor 120 may determine whether the user speech included in the audio signal corresponds to a user registered in the electronic device 101, and may perform a speech verification process when the user speech corresponds to a registered user. When speech is not included in the user image, the processor 120 may perform a verification process (e.g., a lip verification process) on the image that does not include the speech. The lip verification process may be a process of detecting movement of a mouth included in the user image, converting the detected movement of the mouth (e.g., a change in mouth shape) into text corresponding to the detected movement of the mouth by using lip recognizer technology, and verifying whether the converted text matches the expression.

In operation 209, the processor 120 may use the user image as a personalized lip reading model. When the converted text matches the expression, the processor 120 may use the user image as the personalized lip reading model (or a personalized lip reading learning model). The processor 120 may store the user image in a database for the personalized lip reading model (e.g., the memory 130 in FIG. 1). The user image may be used to learn a personalized lip reading model with respect to a mouth shape and text corresponding to the mouth shape (e.g., a displayed expression).

According to various embodiments, the processor 120 may transmit, based on a setting in the electronic device 101 or user input, the user image to a server (e.g., the server 108 in FIG. 1) associated with a typical lip reading model (or a typical lip reading learning model). The processor 120 may transmit the user image to the server 108 when the electronic device 101 is configured to “allow” a user image, used as a personalized lip reading model, to be used as a typical lip reading model. The processor 120 may determine whether a user allows transmitting the user image to the server 108, and may transmit the user image to the server 108 if allowed by the user, and may not transmit the user image to the server 108 if not allowed by the user. The user image transmitted to the server 108 may be used to learn a typical lip reading model with respect to the mouth shape and text corresponding to the mouth shape.

According to various embodiments, the processor 120 may synchronize the time sequence of a mouth movement section with converted text in the user image. The synchronization may refer to matching the mouth movement section with the converted text.

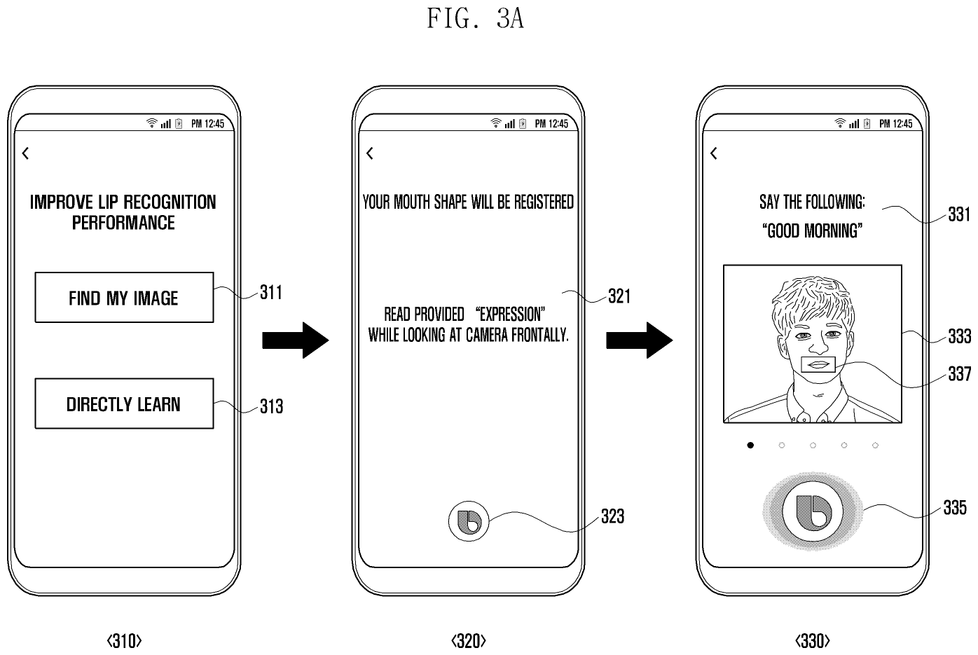

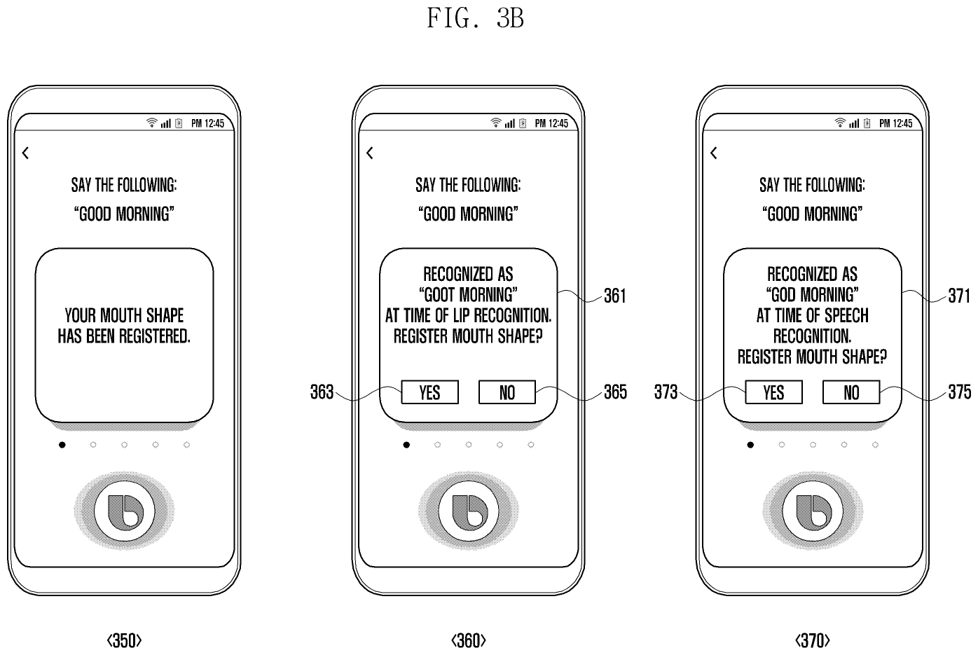

FIGS. 3A and 3B illustrate an example of providing a user interface for acquiring a user image in an electronic device according to various embodiments.

FIG. 3A illustrates an example of a user interface for acquiring a user image.

Referring to FIG. 3A, a processor (e.g., the processor 120 in FIG. 1) of an electronic device (e.g., the electronic device 101 in FIG. 1) according to various embodiments may provide an application associated with a personalized lip reading model, and may provide a first user interface 310 when the application is selected by a user. The application may be installed at the time of manufacture of the electronic device 101. When an icon corresponding to the application is selected, the processor 120 may display the first user interface 310 on a display (e.g., the display device 160 in FIG. 1). The first user interface 310 may be an interface for indicating that a personalized lip reading model can be learned using an image pre-stored in the electronic device 101 (e.g., “find my image” 311) or an image directly captured by the user (e.g., “directly learn” 313).

According to various embodiments, the processor 120 may provide a second user interface 320 when “directly learn” 313 is selected in the first user interface 310. The second user interface 320 may include a guide message 321 and a start button 323. The guide message 321 may provide a user action guide in order to acquire an image necessary for learning a personalized lip reading model. For example, the guide message 321 may be a message making a request for reading a provided expression while looking at a camera frontally. The processor 120 may provide a third user interface 330 when the start button 323 is selected in the second user interface 320. When the start button 323 is selected, the processor 120 may drive a camera (e.g., the camera module 180 in FIG. 1) to capture an image of a user's face. The third interface 330 may include an expression 331, a user image 333 acquired from the camera module 180, and an end button 335. The processor 120 may display a focus 337 in a mouth area in the captured user image 333. When the end button 335 is selected, the processor 120 may acquire the user image 333. The user image 333 may include an audio signal or a video signal.

FIG. 3B illustrates an example of a user interface showing the result of verification of a user image.

Referring to FIG. 3B, a processor (e.g., the processor 120 in FIG. 1) of an electronic device (e.g., the electronic device 101 in FIG. 1) according to various embodiments may provide a fourth user interface 350 for guiding using the user image 333 as a lip reading model. The processor 120 may determine the validity of the user image 333, and when it is determined that there is the validity of the user image 333, the user image 333 may be used as a lip reading model. The validity of the user image 333 may be determined using a speech verification process or a lip verification process. The processor 120 may extract a speech utterance from the user image 333, may convert the extracted speech utterance into text, and may use the user image 333 as a lip reading model when the converted text is the same as the expression 331. The processor 120 may use the entire user image 333 as a lip reading model, or may use a lip image corresponding to the speech utterance, among the user image 333, as a lip reading model. The processor 120 may extract a speech utterance from the user image 333, may convert the extracted speech utterance into text, and may provide a fifth user interface 360 or a sixth user interface 370 when the converted text is not the same as the expression 331.

According to various embodiments, the processor 120 may provide the fifth user interface 360 when text converted using the lip verification process does not match the expression. The fifth user interface 360 may include a guide message 361 including the converted text, a registration button (YES) 363, and a cancel button (NO) 365. The guide message 361 may include: text (e.g., “Goot morning”) converted using the lip verification process; and a message confirming whether to register the converted text as a mouth shape. When the registration button 363 is selected, the processor 120 may register, as a personalized lip reading model, a mouth shape which is extracted from the user image 333 and corresponds to the converted text or displayed expression. Alternatively, when the cancel button 365 is selected, the processor 120 may provide any one of the first user interface 310, the second user interface 320, or the third user interface 330. When the registration button 363 is selected, the processor 120 may register a mouth shape corresponding to the converted text as a personalized lip reading model, and when the cancel button 365 is selected, the processor 120 may provide the third user interface 330. Alternatively, when the registration button 363 is selected, the processor 120 may register a mouth shape corresponding to the displayed expression as a personalized lip reading model, and when the cancel button 365 is selected, the processor 120 may provide the first user interface 310.

According to various embodiments, the processor 120 may provide the sixth user interface 370 when text converted using a speech verification process does not match the expression. The sixth user interface 370 may include a guide message 371 including the converted text, a registration button (YES) 373, and a cancel button (NO) 375. The guide message 371 may include: text (e.g., “God morning”) converted using a speech verification process; and a message confirming whether to register the converted text as a mouth shape. When the registration button 373 is selected, the processor 120 may register, as a personalized lip reading model, a mouth shape corresponding to the converted text or displayed expression. When the cancel button 375 is selected, the processor 120 may provide any one of the first user interface 310, the second user interface 320, or the third user interface 330.

According to various embodiments, since there may be an error in speech recognition, when the registration button 363 is selected, the processor 120 may provide a user interface in which the user corrects the converted text. The user may correct the converted text through the user interface, and the processor 120 may register a mouth shape corresponding to the corrected text as a personalized lip reading model.

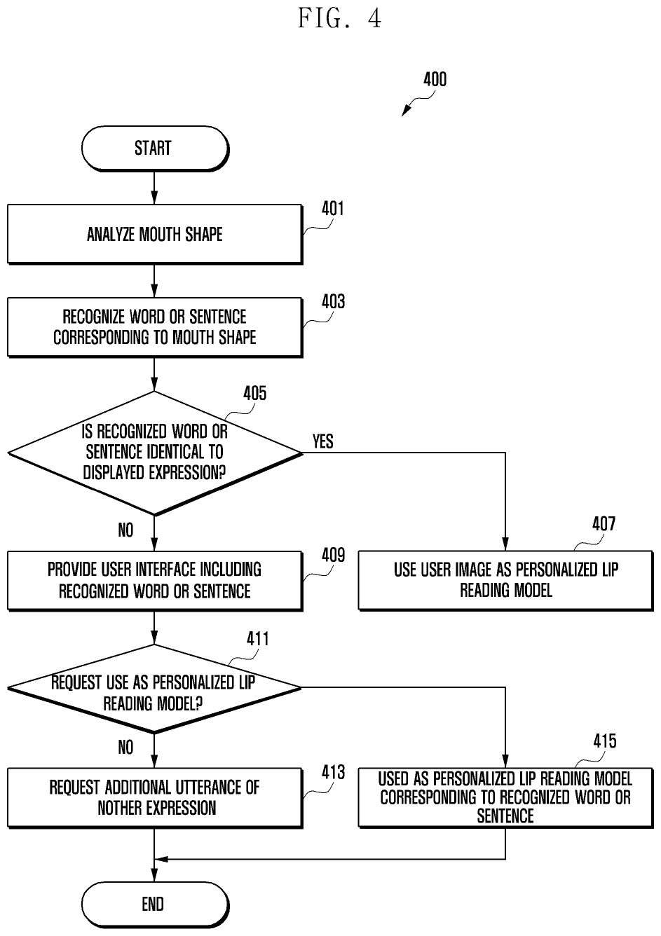

FIG. 4 is a flowchart 400 illustrating a method for verifying a user image, which does not include speech, in an electronic device according to various embodiments. FIG. 4 illustrates operations 205 to 209 in FIG. 2 in detail, and relates to a method for verifying a user image that does not include speech and using the user image as a personalized lip reading model.

Referring to FIG. 4, in operation 401, a processor (e.g., the processor 120 in FIG. 1) of an electronic device (e.g., the electronic device 101 in FIG. 1) according to various embodiments may analyze a mouth shape. The processor 120 may analyze a mouth shape from the user image by using a typical lip reading model. For example, the processor 120 may analyze the mouth shape from the user image by using a typical lip reading model stored in a memory (e.g., the memory 130) of the electronic device 101. The processor 120 may download the typical lip reading model in advance from a server (e.g., the server 108 in FIG. 1) associated with the typical lip reading model and store the typical lip reading model in the memory 130. The typical lip reading model may be a learning model in which a mouth shape is learned by the server 108. Alternatively, the processor 120 may analyze a mouth shape in conjunction with the server (e.g., the server 108 in FIG. 1) associated with the typical lip reading model. The processor 120 may transmit a user image to the server 108 and may receive the result of analysis of a mouth shape in the user image from the server 108. The processor 120 may receive a typical lip reading model from the server 108, and may analyze the mouth shape by using the typical lip reading model.

According to various embodiments, when a user's mouth region is not recognized from the user image, the processor 120 may determine that the selected image is not usable as a personalized lip reading model. When it is determined that the selected image is not usable as a personalized lip reading model, the processor 120 may request user image recapturing.

In operation 403, the processor 120 may analyze a mouth shape in the user image to recognize a word or sentence corresponding to the mouth shape. The processor 120 may analyze a feature point in the user image to detect a facial region including eyes, a nose, and a mouth, may detect the movement of the mouth in the detected facial region, and may recognize a word or sentence corresponding to the detected movement of the mouth. The processor 120 may recognize an uttered sentence or word, uttered by the user and corresponding to movement of the mouth, by using lip recognition technology (e.g., a typical lip reading model stored in the memory 130). According to various embodiments, the processor 120 may recognize a word or sentence corresponding to a mouth shape in conjunction with the server 108. For example, the processor 120 may transmit a user image to the server 108 and receive a word or sentence corresponding to a mouth shape from the server 108.

In operation 405, the processor 120 may determine whether the recognized word or sentence is the same as a displayed expression. The displayed expression may be displayed on a display (e.g., the display device 160) when a user image is acquired. The processor 120 may perform operation 407 when the recognized word or sentence is the same as the displayed expression (YES), and may perform operation 409 when the recognized word or sentence is not the same as the displayed expression (NO).

When the recognized word or sentence is the same as the displayed expression (YES), in operation 407, the processor 120 may use the user image as a personalized lip reading model. In operation 407, the processor 120 may provide the fourth user interface 350 in FIG. 3B to indicate that a determination has been made to use the user image as a personalized lip reading model. The processor 120 may store the user image in a database for the personalized lip reading model (e.g., the memory 130 in FIG. 1). The user image may be used to learn a personalized lip reading model with respect to a mouth shape and a word or sentence corresponding to the mouth shape (e.g., the displayed expression). According to various embodiments, the processor 120 may transmit, based on a setting in the electronic device 101 or user input, the user image to a server (e.g., the server 108 in FIG. 1) associated with a typical lip reading model.

When the recognized word or sentence is not the same as the displayed expression (NO), in operation 409, the processor 120 may provide a user interface including the recognized word or sentence. The recognized word or sentence may be different from the displayed expression, but may have been intentionally spoken by the user differently from the displayed expression. Even when the user intentionally speaks differently from the displayed expression, the processor 120 may provide the fifth user interface 360 in FIG. 3B in order to utilize the user image as a personalized lip reading model according to the user's selection. The processor 120 may determine whether the user will use the mouth shape corresponding to the recognized word or sentence as a personalized lip reading model.

In operation 411, the processor 120 may determine whether there is a request from the user to use the recognized word or sentence as a personalized lip reading model. The user may request that the recognized word or sentence be used as a personalized lip reading model when the recognized word or sentence is different from the displayed expression but corresponds to the shape of his/her mouth. When the registration button 363 is selected while the fifth user interface 360 is displayed, the processor 120 may determine that there is a request to use the recognized word or sentence as a personalized lip reading model (e.g., that usage is allowed). When the cancel button 365 is selected while the fifth user interface 360 is displayed, the processor 120 may determine that there is no request to use the recognized word or sentence as a personalized lip reading model (e.g., that usage is not allowed). The processor 120 may perform operation 415 when there is a request to use the recognized word or sentence as a personalized lip reading model (YES), and may perform operation 413 when there is no request to use the recognized word or sentence as a personalized lip reading model (NO).

When there is no request to use the recognized word or sentence as a personalized lip reading model (NO), in operation 413, the processor 120 may request an additional utterance for another expression. The processor 120 may provide a user interface including an expression different from an expression provided when acquiring the user image. The processor 120 may use the user image as a personalized lip reading model by performing operations 201 to 209 in FIG. 2 with respect to the different expression. The processor 120 may provide a user interface including the same expression as the expression provided when acquiring the user image. According to various embodiments, when there is no request to use the recognized word or sentence as a personalized lip reading model, the processor 120 may provide the first user interface 310 in FIG. 3A. The processor 120 may use a pre-stored image as a personalized lip reading model according to a user's selection, or may acquire a new user image for the different expression and use the new user image as a personalized lip reading model.

When there is a request to use the recognized word or sentence as a personalized lip reading model (YES), in operation 415, the processor 120 may use the recognized word or sentence as the personalized lip reading model corresponding thereto. The processor 120 may store the user image in a database for a personalized lip reading model corresponding to the recognized word or sentence. According to various embodiments, the processor 120 may transmit, based on a setting in the electronic device 101 or user input, the user image to the server 108 associated with the typical lip reading model.

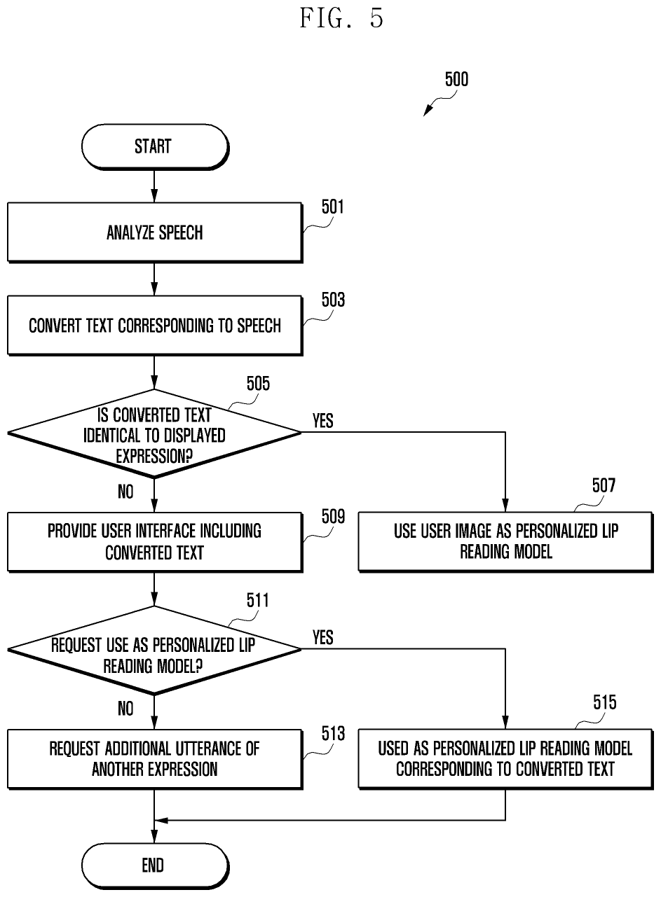

FIG. 5 is a flowchart 500 illustrating a method for verifying a user image, which includes speech, in an electronic device according to various embodiments. FIG. 5 illustrates operations 205 to 209 in FIG. 2 in detail, and relates to a method for verifying a user image including speech and using the same as a personalized lip reading model.

Referring to FIG. 5, in operation 501, a processor (e.g., the processor 120 in FIG. 1) of an electronic device (e.g., the electronic device 101 in FIG. 1) according to various embodiments may analyze speech included in a user image. The processor 120 may extract and analyze an audio signal included in the user image. According to various embodiments, when user speech is included in the audio signal, the processor 120 may determine whether the user speech corresponds to a user registered in the electronic device 101. The processor 120 may analyze the user speech included in the audio signal when the user speech corresponds to a user registered in the electronic device 101.

According to various embodiments, when the user's mouth region is not recognized in the user image, the processor 120 may determine that the selected image is not usable as a personalized lip reading model. When it is determined that the selected image is not usable as a personalized lip reading model, the processor 120 may request user image recapturing.

In operation 503, the processor 120 may convert text corresponding to the speech. The processor 120 may convert the extracted speech into text by using automatic speech recognition (ASR) technology. According to various embodiments, the processor 120 may convert the speech to text corresponding thereto in conjunction with the server 108 or by using the ASR inside the electronic device 101. For example, the processor 120 may transmit a user image to the server 108, and may receive text corresponding to speech extracted from the user image from the server 108.

In operation 505, the processor 120 may determine whether the converted text is the same as a displayed expression. The displayed expression may be displayed on a display (e.g., the display device 160) when a user image is acquired. The processor 120 may perform operation 507 when the converted text is the same as the displayed expression (YES), and may perform operation 509 when the converted text is not the same as the displayed expression (NO).

When the converted text is the same as the displayed expression (YES), in operation 507, the processor 120 may use the user image as a personalized lip reading model. The processor 120 may store the user image in a database for the personalized lip reading model (e.g., the memory 130 in FIG. 1). The user image may be used to learn a personalized lip reading model with respect to a mouth shape and words or sentences corresponding to the mouth shape (e.g., a displayed expression). Since operation 507 is the same as or similar to operation 407 in FIG. 4, a detailed description thereof may be omitted.

When the converted text is not the same as the displayed expression (NO), in operation 509, the processor 120 may provide a user interface including the converted text. The converted text may be different from the displayed expression, but may have been intentionally spoken by the user differently from the displayed expression. The processor 120 may provide the fifth user interface 360 in FIG. 3B in order to use the user image as a lip reading model according to the user's selection. Since operation 509 is the same as or similar to operation 409 in FIG. 4, a detailed description thereof may be omitted.

In operation 511, the processor 120 may determine whether there is a request from the user to use the converted text as a personalized lip reading model. The processor 120 may perform operation 515 when there is a request to use the converted text as a personalized lip reading model (YES), and may perform operation 513 when there is no request to use the converted text as a personalized lip reading model (NO). Since operation 511 is the same as or similar to operation 411 in FIG. 4, a detailed description thereof may be omitted.

When there is no request to use the converted text as a personalized lip reading model (NO), in operation 513, the processor 120 may request additional utterance of another expression. The processor 120 may provide a user interface including an expression different from an expression provided when acquiring the user image. According to various embodiments, when there is no request to use the converted text as a personalized lip reading model, the processor 120 may provide the first user interface 310 in FIG. 3A. Since operation 513 is the same as or similar to operation 413 in FIG. 4, a detailed description thereof may be omitted.

When there is a request to use the converted text as a personalized lip reading model (YES), in operation 515, the processor 120 may use a word or sentence corresponding to the converted text as a personalized lip reading model. The processor 120 may store the user image in a database for a personalized lip reading model corresponding to a recognized word or sentence. Since operation 515 is the same as or similar to operation 415 in FIG. 4, a detailed description thereof may be omitted. According to various embodiments, there may be an error in speech recognition, and thus, when there is the request, the processor 120 may provide a user interface in which the user corrects the converted text. The processor 120 may correct the converted text on the basis of a user input, and may register a word or sentence corresponding to the corrected text as a personalized lip reading model corresponding to a mouth shape.

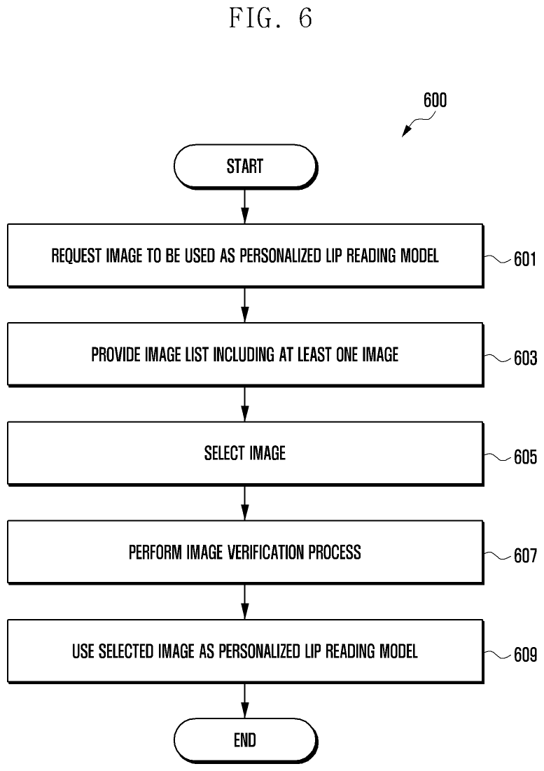

FIG. 6 is a flowchart 600 illustrating a method for using, as a personalized lip reading model, an image pre-stored in an electronic device according to various embodiments.

Referring to FIG. 6, in operation 601, a processor (e.g., the processor 120 in FIG. 1) of an electronic device (e.g., the electronic device 101 in FIG. 1) according to various embodiments may request an image which is to be used as a personalized lip reading model. The processor 120 may provide the first user interface 310 in FIG. 3A, and may receive, from the user, a request to use the pre-stored image as a lip reading model in the first user interface 310. For example, the processor 120 may receive selection of “find my image” 311 in the first user interface 310.

In operation 603, the processor 120 may provide an image list including at least one image. The image list may include images stored in a memory (e.g., the memory 130 in FIG. 1) of the electronic device 101. The image may include a moving image (or a reproducible image) rather than a still image (e.g., a photo). The processor 120 may include all images (e.g., including still images) stored in the memory 130 in the image list. According to various embodiments, the processor 120 may include moving images, among the images stored in the memory 130, in the image list by using file extensions (e.g., avi, mpg, mpeg, mpe, wmv, asf, asx, and mov). The processor 120 may display the image list, including a moving image reproducible for a reference time (e.g., 5 seconds or 10 seconds), on a display (e.g., the display device 160 in FIG. 1). According to various embodiments, the moving image may be an image including one person or an image including a user registered in the electronic device 101. The processor 120 may include an image including one person or an image including a user registered in the electronic device 101, among images stored in the memory 130, in the image list.

In operation 605, the processor 120 may receive selection of an image. The processor 120 may receive, from a user, selection of any one image in the image list. When more than one image is selected, the processor 120 may sequentially perform operations 607 and 609 for each image.

According to various embodiments, the processor 120 may determine whether the selected image is usable as a personalized lip reading model. For example, when a selected image is very dark or bright, it is difficult to use the selected image as a personalized lip reading model, and thus the processor 120 may request the user to reselect an image. When at least two faces are detected from a selected image, it is difficult to use the selected image as a personalized lip reading model, and thus the processor 120 may request the user to reselect an image. When noise (e.g., ambient noise) that has a value equal to or greater than a reference value is detected in a selected image, speech recognition is difficult, and thus the processor 120 may request the user to reselect an image. The processor 120 may selectively request image reselection depending on whether lip recognition is possible in an image in which noise having a value equal to or greater than the reference value is detected. The processor 120 may not request image reselection when lip recognition is possible, and may request image reselection when lip recognition is not possible.

In operation 607, the processor 120 may perform an image verification process for the selected image. The processor 120 may detect whether speech is included in the selected image. When speech is included in the selected image, the processor 120 may perform a verification process (e.g., a speech verification process) for the image including the speech. The speech verification process may be a process of extracting speech included in the selected image, converting the extracted speech into text by using automatic speech recognition (ASR) technology, and verifying whether the converted text is an expression uttered in the selected image. When speech is not included in the selected image, the processor 120 may perform a verification process (e.g., a lip verification process) for the image that does not include the speech. The lip verification process may be a process of detecting the movement of a mouth included in the selected image, recognizing a word or sentence corresponding to the detected movement of the mouth (e.g., a mouth shape change) by using lip recognition technology, and verifying whether the recognized word or sentence is an expression intended by the user in the selected image.

In operation 609, the processor 120 may use the selected image as a personalized lip reading model. When the converted text (e.g., at the time of performing a speech verification process) matches the expression uttered in the selected image, or when the recognized word or sentence (e.g., at the time of performing the lip verification process) matches the expression intended by the user in the selected image, the processor 120 may use the user image or a partial image (a partial image including a lip) of the user image as the personalized lip reading model (or personalized lip reading learning model). The processor 120 may store the selected image in the memory 130. The user image may be used to learn a personalized lip reading model with respect to a mouth shape and a word or sentence corresponding to the mouth shape. According to various embodiments, the processor 120 may transmit, based on user input or a setting in the electronic device 101, the selected image to a server (e.g., the server 108 in FIG. 1) associated with a typical lip reading model (or a typical lip reading learning model).

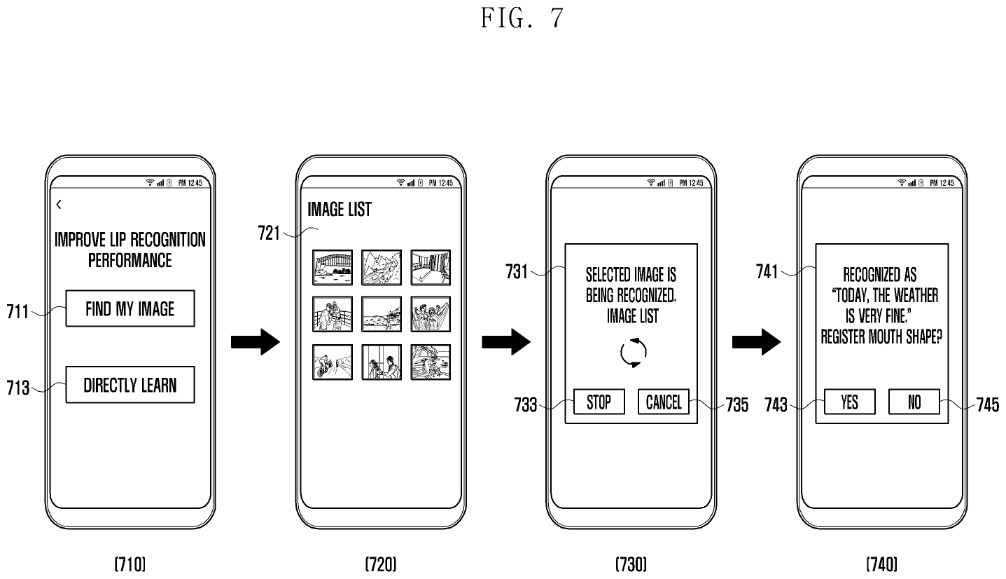

FIG. 7 illustrates an example of providing a user interface for selecting an image pre-stored in an electronic device according to various embodiments.

Referring to FIG. 7, a processor (e.g., the processor 120 in FIG. 1) of an electronic device (e.g., the electronic device 101 in FIG. 1) according to various embodiments may provide a first user interface 710 when an application associated with a personalized lip reading model is selected. The first user interface 710 in FIG. 7 may be the same as the first user interface 310 in FIG. 3A The first user interface 710 may be an interface for indicating that a personalized lip reading model is learned using a pre-stored image (e.g., “find my image” 711) or an image directly captured by a user (e.g., “directly learn” 713).

According to various embodiments, the processor 120 may provide a second user interface 720 when “find my image” 711 is selected in the first user interface 710. The second user interface 720 may include an image list 721. The image list 721 may include at least one image stored in a memory (e.g., the memory 130 in FIG. 1) of the electronic device 101. The image may include a moving image (or a reproducible image) rather than a still image (e.g., a photo). The processor 120 may provide a confirmation button or a cancel button when any one image is selected from the image list 721. The processor 120 may provide a third user interface 730 when the confirmation button is selected after selecting an image.

According to various embodiments, the third user interface 730 may include a message 731 indicating that an image verification process is being performed on the selected image, a stop button 733, and a cancel button 735. The processor 120 may determine whether speech is included in the selected image, and may perform an image verification process (e.g., a speech verification process or a lip verification process) depending on whether speech is included. When the stop button 733 is selected, the processor 120 may stop the image verification process and provide the second user interface 720. When the stop button 733 is selected, the processor 120 may provide the second user interface 720 including an image list for image reselection. When the cancel button 735 is selected, the processor 120 may stop the image verification process and provide the first user interface 710. When the cancel button 735 is selected, the processor 730 may return to the initial screen of an application (e.g., the first user interface 710).

According to various embodiments, the processor 120 may provide a fourth user interface 740, based on the result of verification in the image verification process. The fourth user interface 740 may include a guide message 741 including converted text, a confirmation button (YES) 743, and a cancel button (NO) 745. The processor 120 may provide the fourth user interface 740 in order to check whether the converted text is an expression intended (or uttered) by the user in the selected image. When the confirmation button 743 is selected, the processor 120 may use the selected image as a lip reading model corresponding to the converted text. When the cancel button 745 is selected, the processor 120 may provide the first user interface 710 or the second user interface 720.

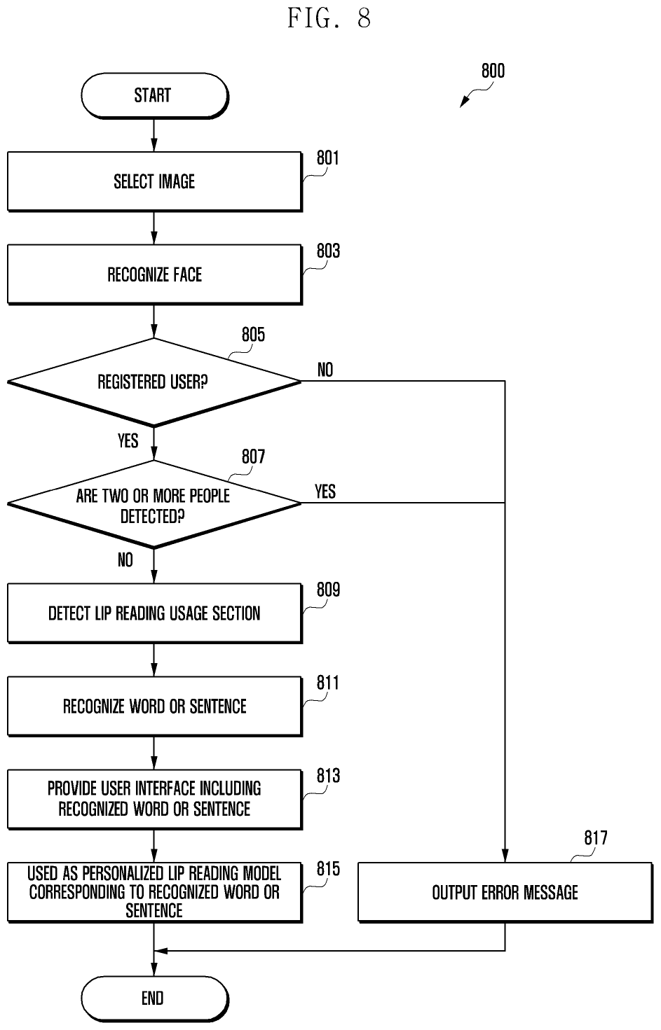

FIG. 8 is a flowchart 800 illustrating a method for using, as a personalized lip reading model, an image pre-stored in an electronic device according to various embodiments. FIG. 8 illustrates detailed operations corresponding to operations 605 to 609 in FIG. 6.

Referring to FIG. 8, in operation 801, a processor (e.g., the processor 120 in FIG. 1) of an electronic device (e.g., the electronic device 101 in FIG. 1) according to various embodiments may receive selection of an image. The processor 120 may receive, from a user, selection of at least one image from an image list including one or more images. The image list may include images stored in a memory (e.g., the memory 130 in FIG. 1) of the electronic device 101. According to various embodiments, the processor 120 may receive selection of one or more images, and when one or more images are selected, may sequentially perform operations 803 to 817 one by one.

In operation 803, the processor 120 may recognize a face included in the selected image. The processor 120 may extract a feature point from the selected image, and may detect a facial region including eyes, a nose, and a mouth by using the extracted feature point. When a facial region is not detected in the selected image, the processor 120 may request image reselection. According to various embodiments, the processor 120 may determine whether the selected image is usable as a personalized lip reading model. When it is determined that the selected image is not usable as a personalized lip reading model, the processor 120 may request the user to reselect an image. For example, when the selected image is too dark or bright, it is difficult to use the selected image as a personalized lip reading model, and thus the processor 120 may request the user to reselect an image.

In operation 805, the processor 120 may determine whether the recognized face corresponds to a registered user. In the electronic device 101, information about a user of the electronic device 101 may be registered in the electronic device (e.g., may be stored in the memory 130) in advance. The information about the user may include at least one of a name, a phone number, an address, or the user's face. The processor 120 may determine whether the recognized face corresponds to a user registered in the electronic device 101. The personalized lip reading model is designed to generate a learning model for an individual user, and when the recognized face does not correspond to a registered user, the selected image may not be used as a personalized lip reading model. The processor 120 may perform operation 807 when the recognized face corresponds to a user registered in the electronic device 101 (YES), and may perform operation 817 when the recognized face does not correspond to a registered user (NO).

When the recognized face corresponds to a registered user (YES), in operation 807, the processor 120 may detect whether there are two or more recognized faces. When the number of people included in the selected image is two or more, it may be difficult to perform the image verification process, or the image verification process may be different. The processor 120 may perform operation 817 when two or more people are detected in the selected image (YES), and may perform operation 809 when two or more people are not detected in the selected image (NO).

In FIG. 8, operation 805 is performed first and operation 807 is performed later. However, operation 807 may be performed first and operation 805 may be performed later, or operation 805 and operation 807 may be performed simultaneously.

When two or more people are not detected in the selected image (NO), in operation 809, the processor 120 may detect a lip reading usage section. The lip reading usage section may include all or part of the selected image. The processor 120 may determine that the section, in which the movement of a mouth is detected in the facial region of the selected image and in which the detection time of the movement of the mouth is equal to or longer than a reference time (e.g., 5 seconds or 10 seconds), is a lip reading usage section. The processor 120 may perform operations 811 to 815 in the entire section of the selected image, but may perform operations 811 to 815 in the lip reading usage section in order to reduce a load on the processor 120.

In operation 811, the processor 120 may recognize a word or a sentence from the lip reading usage section. For example, when the speech is included in the lip reading usage section, the processor 120 may extract the speech included in the lip reading usage section, and may convert the extracted speech into text by using automatic speech recognition (ASR) technology, thereby recognizing the word or the sentence. When the speech is not included in the lip reading usage section, the processor 120 may detect movement of the mouth included in the lip reading usage section, and may recognize a word or sentence corresponding to the detected movement of the mouth (e.g., a change in mouth shape) by using lip recognition technology.

In operation 813, the processor 120 may provide a user interface including the recognized word or sentence. The processor 120 may display the user interface on a display (e.g., the display device 160) in order to determine whether the recognized word or sentence is an expression intended (or uttered) by the user in the lip reading usage section. For example, the user interface may include the fifth user interface 360 or the sixth user interface 370 in FIG. 3B. The user interface may include a guide message including the recognized word or sentence, a registration button, and a cancel button. The user may check the recognized word or sentence, and may select the registration button when the recognized word or sentence is the expression intended by the user in the selected image.

In operation 815, the processor 120 may use the selected image as a personalized lip reading model corresponding to the recognized word or sentence. The processor 120 may register the recognized word or sentence as a personalized lip reading model corresponding to a mouth shape. The processor 120 may store the selected image in a database for the personalized lip reading model (e.g., the memory 130 in FIG. 1). The processor 120 may store the entire selected image or the lip reading usage section in the memory 130, based on a setting in the electronic device 101 or the user's selection. According to various embodiments, the processor 120 may transmit, based on a setting in the electronic device 101 or user input, the user image to a server (e.g., the server 108 FIG. 1) associated with a typical lip reading model (or a typical lip reading learning model).

When the recognized face does not correspond to a registered user (NO) or when two or more people are detected in the selected image (YES), the processor 120 may output an error message in operation 817. The selected image is used to generate a personalized lip reading model. When the selected image is difficult to use as a personalized lip reading model, the processor 120 may output the error message. For example, the error message may include a message requesting image reselection. When the recognized face does not correspond to a registered user, the processor 120 may include, in the error message, a guide message to select an image that includes the registered user. When two or more people are detected in the selected image, the processor 120 may include, in the error message, a guide message to select an image that includes one registered user.

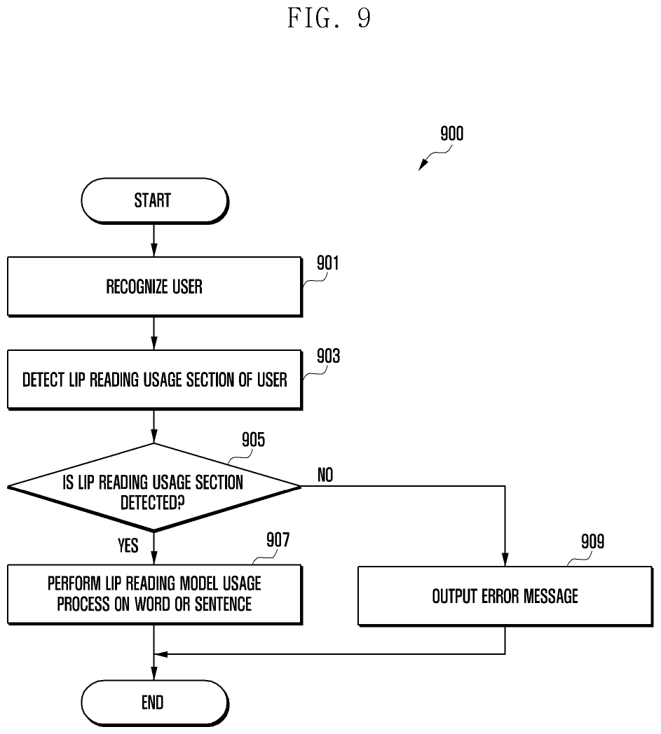

FIG. 9 is a flowchart 900 illustrating a method for using a pre-stored image, which includes two or more users, as a personalized lip reading model in an electronic device according to various embodiments. FIG. 9 specifically illustrates an operation performed when two or more people are included in the image selected in operation 807 in FIG. 8 (YES).

Referring to FIG. 9, in operation 901, a processor (e.g., the processor 120 in FIG. 1) of an electronic device (e.g., the electronic device 101 in FIG. 1) according to various embodiments may recognize a user. When two people are included in the image selected in operation 801, the processor 120 may recognize (or extract) a user registered in the electronic device 101 from among the two people. The processor 120 may extract a feature point from the selected image, and may recognize, based on the extracted feature point, the user registered in the electronic device 101. According to various embodiments, when lip recognition is difficult for the user recognized in the selected image, the processor 120 may request the user to reselect an image. For example, when the mouth region of the recognized user is not recognized according to the brightness of the selected image, the processor 120 may determine that the selected image is not usable as a personalized lip reading model. Alternatively, when the length of the image including the recognized user is less than or equal to a reference time (e.g., 5 seconds or 10 seconds), the processor 120 may determine that the selected image is not usable as a personalized lip reading model. When it is determined that the selected image is not usable as a personalized lip reading model, the processor 120 may request image reselection.

In operation 903, the processor 120 may detect a user's lip reading usage section. The lip reading usage section may include all or part of the selected image. The processor 120 may determine that a section, in which the movement of the recognized user's mouth is detected in the selected image and in which the detection time of the movement of the mouth is equal to or longer than a reference time (e.g., 5 seconds or 10 seconds), is the lip reading usage section. Since operation 903 is the same as or similar to operation 809, a detailed description thereof may be omitted.

In operation 905, the processor 120 may determine whether a lip reading usage section is detected in the selected image. The processor 120 may detect whether there is a section in which the movement of the recognized user's mouth is detected in the selected image for a time equal to or longer than the reference time. The processor 120 may perform operation 907 when the lip reading usage section is detected (YES), and may perform operation 909 when the lip reading usage section is not detected (NO).

When the lip reading usage section is detected (YES), in operation 907, the processor 120 may perform a lip reading model usage process according to a word or a sentence. The lip reading use process may be a process of: recognizing a word or sentence corresponding to the shape of the recognized user's mouth from the lip reading usage section; and using the selected image as a personalized lip reading model, based on whether the recognized word or sentence is the same as an expression intended (or uttered) by the recognized user. The lip reading use process may include operations 811 to 815 in FIG. 8. For example, when the recognized word or sentence is the same as the expression intended by the recognized user, the processor 120 may use the selected image as a personalized lip reading model, and when the converted text is not the same as the expression intended by the recognized user, the processor 120 may not use the selected image as a personalized lip reading model. When the recognized word or sentence is not the same as the expression intended (or uttered) by the user, the processor 120 may request the user to reselect an image.

According to various embodiments, the processor 120 may extract speech from the lip reading usage section, and may convert text, based on the extracted speech. Alternatively, the processor 120 may detect movement of the mouth from the lip reading usage section, and may recognize a word or sentence corresponding to the detected movement of the mouth.

When the lip reading usage section is not detected (NO), the processor 120 may output an error message in operation 909. For example, the error message may include a message requesting image reselection. The processor 120 may include, in the error message, a guide message to select an image including one registered user. Since operation 909 is the same as or similar to operation 817, a detailed description thereof may be omitted.

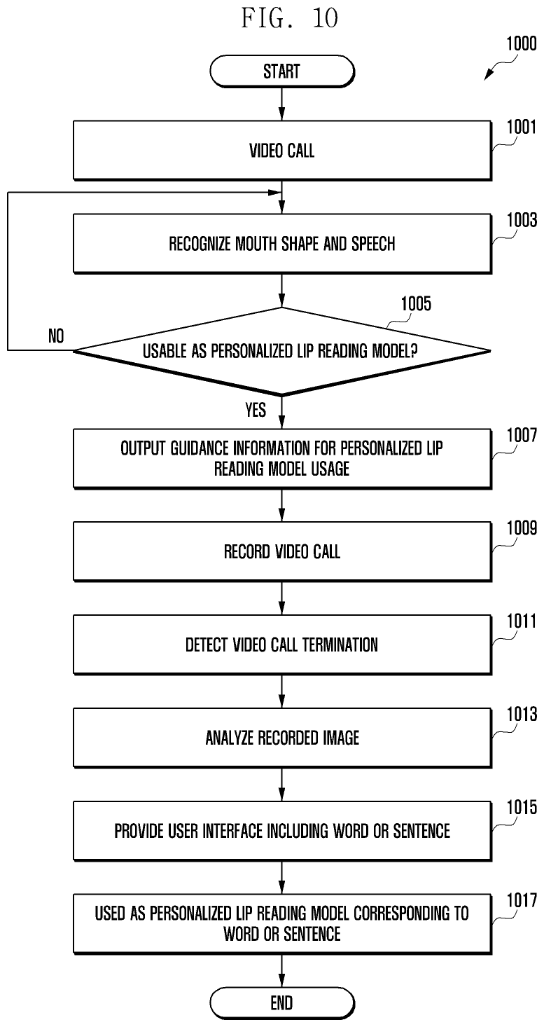

FIG. 10 is a flowchart 1000 illustrating a method for acquiring a user image during a video call and using the user image as a personalized lip reading model in an electronic device according to various embodiments.

Referring to FIG. 10, in operation 1001, a processor (e.g., the processor 120 in FIG. 1) of an electronic device (e.g., the electronic device 101 in FIG. 1) according to various embodiments may perform a video call. The processor 120 may receive or send a video call in response to a user's request. The processor 120 may perform the video call by driving a camera (e.g., the camera module 180 in FIG. 1) or a speaker (e.g., the sound output device 155) of the electronic device 101. The processor 120 may display an execution screen of an application associated with the video call on a display (e.g., the display device 160), and may output sound associated with the video call through the sound output device 155. The execution screen (e.g., a video call user interface) may include: a user image acquired from the camera module 180; and a counterpart image received from a counterpart electronic device (e.g., the electronic device 102 in FIG. 1).

According to various embodiments, the processor 120 may store the execution screen in a memory (e.g., the memory 130 in FIG. 1), based on a setting in the electronic device 101 or user selection. When the electronic device 101 is set to “automatically store during a video call”, the processor 120 may automatically store an execution screen of an application associated with the video call or a user image during a video call. The processor 120 may indicate that a video call can be stored as a user image which is to be used as a lip reading model during the video call, and when the user makes a request to “store”, may store an execution screen of an application associated with the video call or a user image. The user image may include a video signal acquired from the camera module 180 (e.g., a front camera) and an audio signal acquired from a microphone (e.g., the input device 150 in FIG. 1). According to various embodiments, the processor 120 may store the execution screen (e.g., including a counterpart image and a user image) or a user image, including a user, in the execution screen. The processor 120 may store an image, which includes the user and a part of the execution screen, as the user image.

In operation 1003, the processor 120 may recognize a mouth shape and speech from the video call. The processor 120 may recognize a mouth shape from the execution screen or the user image, and may recognize speech by using an audio signal acquired from a microphone (e.g., the input device 150 in FIG. 1). According to various embodiments, the processor 120 may recognize the mouth shape and the speech from the video call for a predetermined time (e.g., 5 seconds or 10 seconds).

In operation 1005, the processor 120 may determine whether the video call is usable as a personalized lip reading model. According to various embodiments, the processor 120 may determine whether the video call is usable as a personalized lip reading model, based on at least one of whether a user registered in the electronic device 101 is included in the video call, whether two or more people are included in the video call, and an image-capturing state. For example, the processor 120 may determine whether the user whose speech is recognized is the registered user, and may determine that the video call is usable as a personalized lip reading model when it is determined that the user whose speech is recognized is the registered user. Alternatively, the processor 120 may extract a feature point from a user image acquired from the camera module 180, and may determine, based on the extracted feature point, whether the user whose speech is recognized is the registered user. The processor 120 may extract a feature point from a user image acquired from the camera module 180, and when the facial region of one person is detected based on the extracted feature point, may determine that the video call is usable as a personalized lip reading model.

According to various embodiments, the image-capturing state may include whether the brightness of a user image acquired from the camera module 180 falls within a predetermined range or whether detected noise (e.g., ambient noise) of an audio signal acquired from a microphone (e.g., the input device 150 in FIG. 1) has a value equal to or greater than a reference value. When the brightness of the user image is included in the predetermined range, the processor 120 may determine that the video call is usable as a personalized lip reading model. When the detected noise of the audio signal has a value smaller than the reference value, the processor 120 may determine that the video call is usable as a personalized lip reading model. When the video call is usable as a personalized lip reading model (YES), the processor 120 may perform operation 1007, and when the video call is not usable as a personalized lip reading model (NO), the processor 120 may return to operation 1003.

According to various embodiments, when the video call is not usable as a personalized lip reading model (NO), the processor 120 may inform the user that the video call is not usable as a personalized lip reading model.

When the video call is usable as a lip reading model (YES), in operation 1007, the processor 120 may output guidance information for using the video call as a personalized lip reading model. The processor 120 may include the guidance information in the execution screen of an application associated with the video call. The guidance information may be displayed as text or an image. For example, the guidance information may include an icon-type guide image or a guide message indicating that a video call can be recorded.

In operation 1009, the processor 120 may record (or store) a video call. When the output guide image is selected, the processor 120 may record the video call. According to various embodiments, the processor 120 may store an execution screen of an application associated with the video call or a user image in the memory 130. The processor 120 may store the entire image of the video call or a partial image thereof usable as a personalized lip reading model. The recorded image may be included in the image list provided in operation 603 shown in FIG. 6.

In operation 1011, the processor 120 may detect whether the video call is terminated. When an end button is selected on the execution screen or when a request for call termination is made by a counterpart electronic device, the processor 120 may determine that the video call is terminated. When video call termination is detected, the processor 120 may stop driving the camera module 180 or the sound output device 155.

In operation 1013, when the video call is terminated, the processor 120 may analyze the recorded video. Different processes may be performed depending on whether the recorded video includes speech. When the recorded video includes speech, the processor 120 may extract the speech included in the recorded video, may convert the extracted speech into text by using automatic speech recognition (ASR) technology, and may acquire a word or sentence corresponding to the converted text. Alternatively, when speech is not included in the recorded image, the processor 120 may detect movement of a mouth included in the recorded image, and may recognize a word or sentence corresponding to the detected movement of the mouth by using lip recognition technology.

In operation 1015, the processor 120 may provide a user interface including the word or sentence. The processor 120 may display the user interface on a display (e.g., the display device 160) in order to determine whether the recognized (or acquired) word or sentence is an expression intended (or uttered) by the user. For example, the user interface may include the fifth user interface 360 or the sixth user interface 370 in FIG. 3B. Since operation 1015 is the same as or similar to operation 813, a detailed description thereof may be omitted.

In operation 1017, the processor 120 may use a personalized lip reading model corresponding to the word or sentence. The processor 120 may register the word or sentence as a personalized lip reading model corresponding to the mouth shape. The processor 120 may store the recorded image in a database for the personalized lip reading model (e.g., the memory 130 in FIG. 1). The processor 120 may store all or part of the recorded image in the memory 130, based on a setting in the electronic device 101 or the user's selection. Since operation 1017 is the same as or similar to operation 815, a detailed description thereof may be omitted.

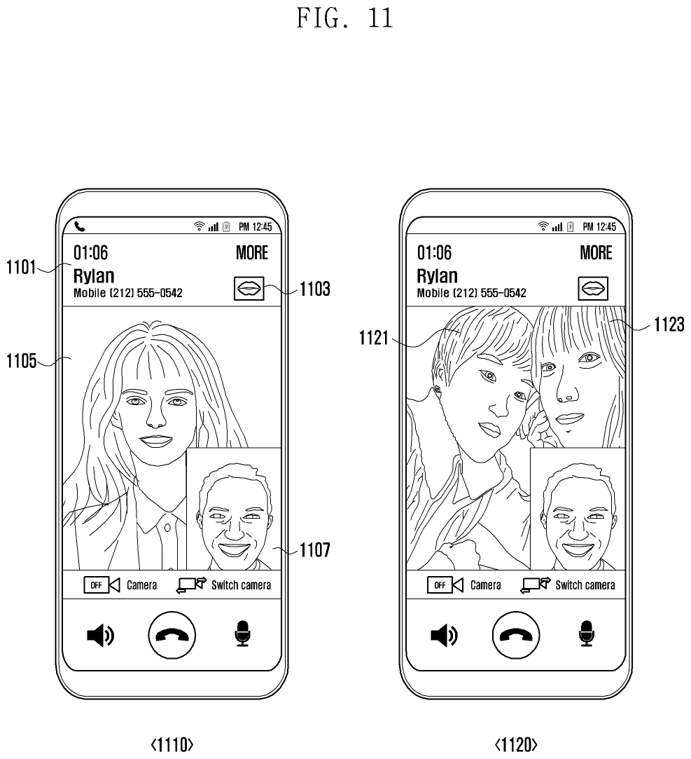

FIG. 11 illustrates an example of providing a user interface including a video call in an electronic device according to various embodiments.

Referring to FIG. 11, a processor (e.g., the processor 120 in FIG. 1) of an electronic device (e.g., the electronic device 101 in FIG. 1) according to various embodiments may provide a first user interface 1110 in relation to a video call. The first user interface 1110 may be an execution screen of an application associated with a video call. The first user interface 1110 may include video call information 1101, a guide image 1103 for personalized lip reading model usage, a user image 1105, and a counterpart image 1107. The video call information 1101 may include video call time or counterpart information (e.g., a name or phone number). The guide image 1103 indicates that personalized lip reading model usage is possible, and may be provided in the form of an icon. The user image 1105 may include an image acquired from a camera (e.g., the camera module 180 in FIG. 1). The counterpart image 1107 may include an image received from a counterpart electronic device (e.g., the electronic device 102 in FIG. 1).

According to various embodiments, the processor 120 may store the first user interface 1110 or the user image 1105 in a memory (e.g., the memory 130 in FIG. 1) according to a setting in the electronic device 101 or a user's selection. For example, when the electronic device 101 is set to “automatically store during a video call”, the processor 120 may automatically store the first user interface 1110 or the user image 1105 during the video call. When the guide image 1103 is selected by the user, the processor 120 may store the first user interface 1110 or the user image 1105.

According to various embodiments, the processor 120 may provide a second user interface 1120 in relation to a video call. The second user interface 1120 may include a user image including a first user 1121 and a second user 1123. When two people are included in the user image, the processor 120 may not store the second user interface 1120 or the user image including two people. Alternatively, when one of the first user 1121 or the second user 1123 is a user registered in the electronic device 101, the processor 120 may detect a lip reading usage section and store the detected lip reading usage section.

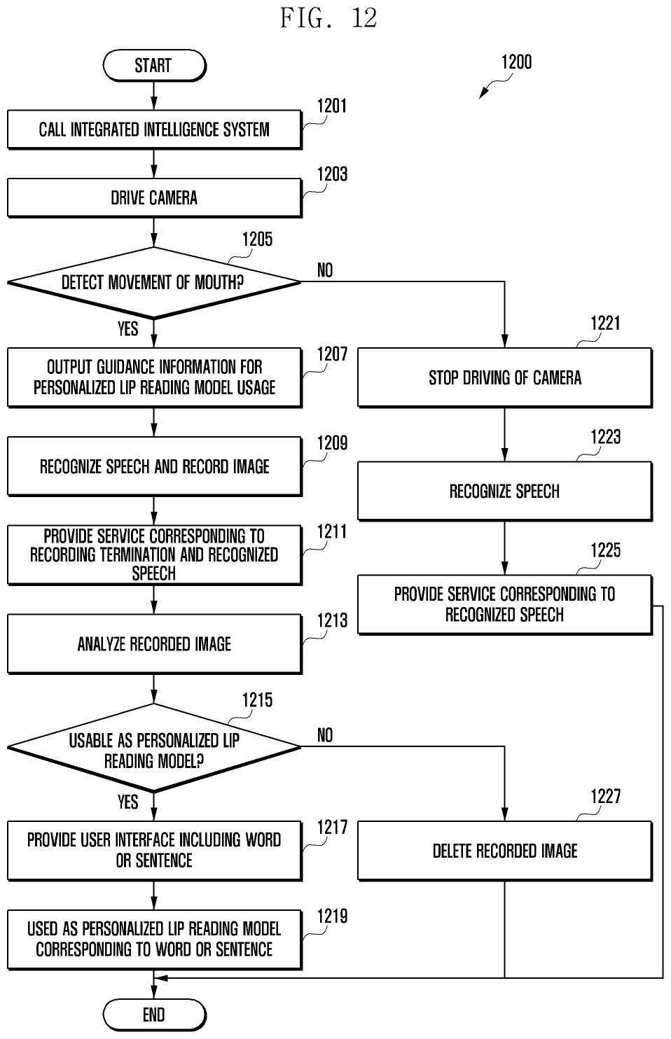

FIG. 12 is a flowchart 1200 illustrating a method for acquiring a user image when an integrated intelligence (AI) system call is performed and using the user image as a personalized lip reading model in an electronic device according to various embodiments.

Referring to FIG. 12, in operation 1201, a processor (e.g., the processor 120 in FIG. 1) of an electronic device (e.g., the electronic device 101 in FIG. 1) according to various embodiments may recognize an integrated intelligence (AI) system call. The processor 120 may receive speech from a microphone (e.g., the input device 150 in FIG. 1), and when the received speech corresponds to a preset wake-up word (e.g., “Bixby”), may recognize that the integrated intelligence system is called. When the received speech corresponds to a preset wake-up word and a preset button (e.g., a home button, a lock button) is selected, the processor 120 may recognize that the integrated intelligence system is called.

In operation 1203, the processor 120 may drive (or activate) a camera (e.g., the camera module 180 in FIG. 1). When the integrated intelligence system call is recognized, the processor 120 may activate a front camera to acquire a user image from the camera module 180, and may recognize a face from the user image.

In operation 1205, the processor 120 may determine whether movement of a mouth is detected in the user image. The processor 120 may extract a feature point from the user image, may recognize a facial region by using the extracted feature point, and may detect the movement of the mouth from the recognized facial region. The processor 120 may perform operation 1207 when movement of the mouth is detected (YES), and may perform operation 1221 when movement of the mouth is not detected (NO).

When the movement of the mouth is detected (YES), in operation 1207, the processor 120 may output guidance information for personalized lip reading model usage. The processor 120 may include the guidance information in an execution screen of an application associated with an integrated intelligence system call. The guidance information may be displayed as text or an image. For example, the guidance information may include an icon-type guide image or a guide message indicating that a user image can be recorded.

In operation 1209, the processor 120 may recognize speech, and may record the user image. The processor 120 may acquire speech received after the preset wake-up word, and may recognize the acquired speech. The processor 120 may interwork with a speech recognition server (e.g., the server 108) in order to perform speech recognition. According to various embodiments, the processor 120 may record the user image, based on a setting in the electronic device 101 or user selection. When the electronic device 101 is set to “automatically store during a speech call”, the processor 120 may record the user image. When the guide image is selected, the processor 120 may record the user image.

In operation 1211, the processor 120 may provide a service corresponding to recording termination and the recognized speech. The processor 120 may transmit the speech acquired from the input device 150 to the speech recognition server (e.g., the server 108), and may receive an instruction corresponding to the speech from the server 108. The processor 120 may provide, based on the received instruction, a service corresponding to the recognized speech. For example, the processor 120 may play song XX in response to the speech “play song XX”. When speech is not acquired from the input device 150, the processor 120 may stop driving the camera module 180, and may terminate recording (or storage) of the user image.

In operation 1213, the processor 120 may analyze the recorded image. The processor 120 may extract speech included in the recorded user image, may convert the extracted speech into text by using automatic speech recognition (ASR) technology, and may acquire a word or sentence from the converted text. In addition, the processor 120 may detect movement of the mouth included in the recorded user image, and may recognize a word or sentence corresponding to the detected movement of the mouth by using lip recognition technology. According to various embodiments, the processor 120 may synchronize the time sequence of a mouth movement section with the word or sentence recognized (or acquired) in the user image. The synchronization may refer to matching a mouth movement section with a recognized word or sentence.

In operation 1215, the processor 120 may determine whether the recorded user image is usable as a personalized lip reading model. According to various embodiments, the processor 120 may determine whether the user image is usable as a personalized lip reading model, based on at least one of whether two or more people are included in the user image, an image-capturing state, and an image length. When the user image is long to be reproducible for a reference time or more, the processor 120 may determine that the user image is usable as a personalized lip reading model. Since operation 1215 is the same as or similar to operation 1005, a detailed description thereof may be omitted. The processor 120 may perform operation 1217 when the user image is usable as a personalized lip reading model (YES), and may perform operation 1227 when the user image is not usable as a personalized lip reading model (NO).

When the user image is usable as a personalized lip reading model (YES), in operation 1217, the processor 120 may provide a user interface including the word or sentence. The processor 120 may display the user interface on a display (e.g., the display device 160) in order to determine whether the word or sentence is an expression intended (or uttered) by the user in the lip reading usage section. Since operation 1217 is the same as or similar to operation 813, a detailed description thereof may be omitted.

In operation 1219, the processor 120 may use a personalized lip reading model corresponding to the recognized word or sentence. The processor 120 may register the recognized word or sentence as a personalized lip reading model corresponding to a mouth shape. The processor 120 may store the recorded image in a database for the personalized lip reading model (e.g., the memory 130 in FIG. 1). The processor 120 may store all or part of the recorded image in the memory 130, based on a setting in the electronic device 101 or the user's selection. Since operation 1219 is the same as or similar to operation 815, a detailed description thereof may be omitted.

When the movement of the mouth is not detected (NO), the processor 120 may stop driving the camera in operation 1221. The processor 120 may drive the camera module 180 to acquire a user image, but may stop driving the camera module 180 when movement of the mouth is not detected in the acquired user image.

In operation 1223, the processor 120 may recognize speech. The processor 120 may acquire speech received after the preset wake-up word, and may recognize the acquired speech. The processor 120 may interwork with the speech recognition server (e.g., the server 108) in order to perform speech recognition.

In operation 1225, the processor 120 may provide a service corresponding to the recognized speech. The processor 120 may transmit the speech acquired from the input device 150 to the server 108, and may receive an instruction corresponding to the speech from the server 108. The processor 120 may provide, based on the received instruction, a service corresponding to the recognized speech. The processor 120 may end the operation after providing the service. Alternatively, after providing the service, the processor 120 may activate the input device 150 to detect whether a preset wake-up word is received.

When the user image is not usable as a personalized lip reading model (NO), the processor 120 may delete the recorded user image in operation 1227. The processor 120 may not store the recorded user image in the memory 130.

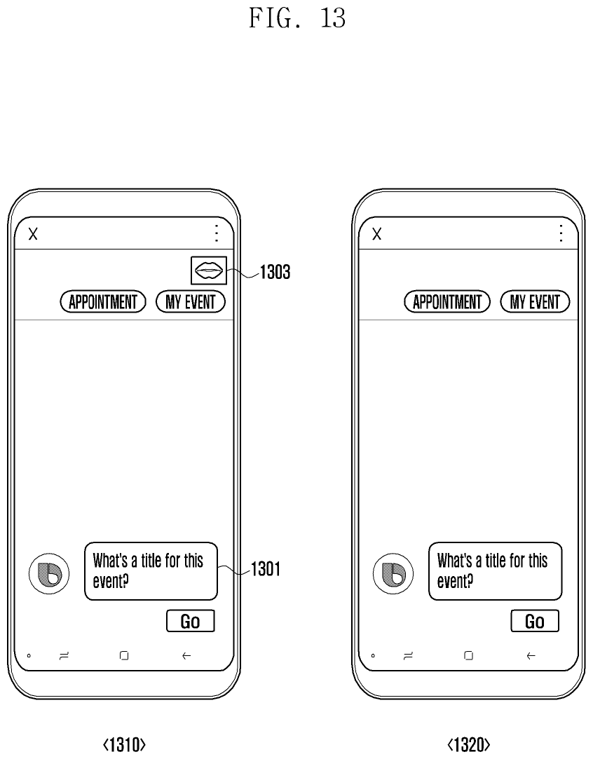

FIG. 13 illustrates an example of providing a user interface associated with a speech call in an electronic device according to various embodiments.

Referring to FIG. 13, a processor (e.g., the processor 120 in FIG. 1) of an electronic device (e.g., the electronic device 101 in FIG. 1) according to various embodiments may provide a first user interface 1310 or a second user interface 1320 in relation to a speech call. The first user interface 1310 may include a service screen (e.g., an application execution screen) provided in response to recognized speech. The first user interface 1310 may include text 1301 corresponding to the recognized speech and a guide image 1303 for lip reading model usage. The processor 120 may provide the first user interface 1310 when a user image acquired from a camera (e.g., the camera module 180 in FIG. 1) can be used for a lip reading model when a speech call is made. The processor 120 may provide the second user interface 1320 when the user image cannot be used for a lip reading model.

An operation method of an electronic device according to various embodiments of the disclosure may include: driving a camera of the electronic device in response to a speech call; determining whether movement of a mouth is detected in a user image received from the driven camera; recording the user image when the movement of the mouth is detected in the user image; providing a service corresponding to speech received during the speech call; and using the recorded user image as a personalized lip reading model.

The method may further include outputting guidance information for using the user image as the personalized lip reading model when movement of the mouth is detected in the user image.

The method may further include stopping the driving of the camera when movement of the mouth is not detected in the user image.

The method may include: determining whether the recorded user image is usable as the personalized lip reading model; when the recorded user image is usable as the personalized lip reading model on the basis of the determination result, storing the recorded user image in a memory of the electronic device as the personalized lip reading model corresponding to a word or sentence recognized from the recorded user image; and deleting the recorded user image when the recorded user image is not usable as the personalized lip reading model on the basis of the determination result.

The various embodiments of the disclosure, disclosed in the specification and drawings, are merely specific examples provided to easily explain the technical content of the disclosure and to help understand the disclosure, and are not intended to limit the scope of the disclosure. Therefore, it should be construed that all modifications or modified forms capable of being derived from the technical spirit of the disclosure, in addition to the embodiments disclosed herein, fall within the scope of the disclosure.

1. An electronic device comprising:
a memory;
a display;
a camera; and
a processor,
wherein the processor is configured to:
display a user interface, comprising at least one expression, on the display;
acquire a user image associated with the expression from the camera;
verify the user image, based on whether speech is included in the user image; and
store the user image in the memory as an image which is to be used as a personalized lip reading model, based on a result of the verification.

2. The electronic device of claim 1, wherein the processor is configured to:
when speech is included in the user image, extract the speech included in the user image;
convert the extracted speech into text; and
verify the user image, based on whether the converted text matches the expression.

3. The electronic device of claim 1, wherein the processor is configured to:
detect movement of a mouth included in the user image when speech is not included in the user image;
recognize a word or sentence corresponding to the detected movement of the mouth; and
verify the user image, based on whether the recognized word or sentence matches the expression.

4. The electronic device of claim 1, wherein the processor is configured to use the user image as a personalized lip reading model corresponding to the expression when a word or sentence recognized from the user image is identical to the expression.

5. The electronic device of claim 1, wherein the processor is configured to:
when a word or sentence recognized from the user image is not identical to the expression, provide a user interface comprising the recognized word or sentence; and
store the user image in the memory as an image which is to be used, based on a user's selection, as a personalized lip reading model corresponding to the recognized word or sentence.

6. The electronic device of claim 5, wherein the processor is configured to:
receive, from the user, a request to correct the recognized word or sentence; and
store the user image in the memory as an image which is to be used as a personalized lip reading model corresponding to the word or sentence corrected by the correction request.

7. The electronic device of claim 1, wherein the processor is configured to provide a user interface comprising an expression different from the expression when a word or sentence recognized from the user image is not identical to the expression.

8. The electronic device of claim 1, wherein the processor is configured to:
provide an image list comprising at least one image, based on a request to use the image as a personalized lip reading model;
select at least one image from the image list; and
verify the selected image and store the selected image in the memory as an image which is to be used as the personalized lip reading model.

9. The electronic device of claim 1, wherein the processor is configured to provide the image list, based on a file extension or a reproduction time of each of images stored in the memory.

10. The electronic device of claim 1, wherein the processor is configured to:
determine whether the selected image is usable as the personalized lip reading model; and
request image reselection when it is determined that the selected image is not usable as the personalized lip reading model.

11. The electronic device of claim 1, wherein the processor is configured to:
recognize a face from the selected image;
determine whether the recognized face corresponds to a user registered in the electronic device; and
output an error message when it is determined that the recognized face does not correspond to the user registered in the electronic device.

12. The electronic device of claim 1, wherein the processor is configured to:
recognize faces from the selected image; and
when the number of the recognized faces is equal to or greater than two, recognize a user registered in the electronic device from among the two or more faces;
recognize a word or a sentence, based on a shape of a mouth of the recognized user; and
perform a lip reading model usage process for the recognized word or sentence.

13. The electronic device of claim 12, wherein the processor is configured to:
detect a lip reading usage section from the selected image;
convert speech extracted from the detected lip reading usage section into text;
provide a user interface comprising the converted text; and
store the selected image in the memory as an image which is to be used as the personalized lip reading model, based on a user's selection.

14. The electronic device of claim 13, wherein the processor is configured to:
receive a registration request from the user when the converted text corresponds to an expression intended by the user; and
use, based on the registration request, the selected image as a personalized lip reading model corresponding to the converted text.

15. An operation method of an electronic device, comprising:
driving a camera of the electronic device in response to a speech call;
determining whether movement of a mouth is detected in a user image received from the driven camera;
recording the user image when movement of the mouth is detected in the user image;
providing a service corresponding to speech received during the speech call; and
using the recorded user image as a personalized lip reading model.
